(19) United States
(12) Patent Application Publication
(10) Pub. No.: US 2004/0178914 A1
(43) Pub. Date: Sep. 16, 2004

(54) Flame sensor and method of using same

(75) Inventor: Nader Kiarostami, Delta (CA)

Correspondence Address: John Russell Uren, P. Eng., Suite 202, 1590 Bellevue Avenue, West Vancouver, British Columbia, V7V 1A7, CA

(73) Assignee: INTERNATIONAL THERMAL INVESTMENTS LTD.

(21) Appl. No.: 10/441,929

(22) Filed: May 19, 2003

(30) Foreign Application Priority Data
Mar. 11, 2003 (CA) 2,421,664

(51) Int. Cl. G08B 17/12

(52) U.S. Cl. 340/577

(57) ABSTRACT

A circuit for a flame sensor and a method for sensing the presence of a flame in a burner. The signal from the sensor is passed to an amplifier located adjacent to the sensor and amplified without having a sensor signal contaminated with common mode radiation. The pulsed signal is passed from the amplifier to a rectifier. The pulsed signal of the amplifier is a fully amplified signal.

This invention relates to a flame sensor for a burner and, more particularly, to a flame sensor in which pulsed signal amplification occurs at or near the sensor itself and further wherein feedback following amplification of the pulsed signal is eliminated thereby leading to increased reading sensitivity of the pulsed signal generated by the photodiode in sensing the flame.

### BACKGROUND OF THE INVENTION

Flame sensors are used to sense the presence or absence of a flame in a heater or burner, for example, or other apparatus. The heater or burner may be used to heat water or ambient air and the fuel used may be one of several different types.

In the event the flame is extinguished, although not deliberately so, the sensor is adapted to sense the absence of the flame. The flame can be extinguished, for example, by fuel starvation or other malfunction. After sensing the extinguishing of the flame, the sensor or its related circuitry will send an alarm signal to a microcontroller. The microcontroller will take appropriate action such as shutting down the heater or burner by terminating fuel flow. In such a manner, serious safety problems such as continued fuel flow into a hot burner without a flame being present for combusting the fuel are avoided.

However, it is inconvenient to terminate the fuel flow if the flame is present and the burner is working properly. The termination of the fuel flow causes termination of the operation of the burner or heater unintendedly if the flame sensor sends an incorrect signal to the control panel. The present invention has as an object the avoidance of inadvertent burner shutdown and, as well, the avoidance of burner operation when the flame is extinguished.

One reason for unintended burner shutdown is signal contamination of the signal from the flame sensor, Since the power of the signal previously sent to the amplifier is quite small, in the range of 50 mv to 200 mv, and since the amplifier was located some distance from the sensor, any noise caused by common mode radiation or other RF signals could disrupt the integrity of the signal being passed to the amplifier by the sensor. This causes incorrect information to be read by the microcontroller with the result that the heater could be inadvertently shut down or, alternatively, the heater may continue to run in a flame out condition. Both scenarios are not desirable.

In our U.S. patent application Ser. No. 09/579,444 filed May 26, 2000, the contents of which are incorporated herein by reference, there is disclosed a circuit for a flame sensor which utilises an amplifier and rectifier circuit in which full amplification of the pulsed signal leaving the amplifier does not take place due to a feedback loop between the output of the amplifier and the inverting input of the amplifier. This leads to a decreased reading sensitivity of the pulsed signal generated by the photodiode of the flame sensor.

### SUMMARY OF THE INVENTION

According to one aspect of the invention, there is provided a method of sensing a flame using an amplifier circuit comprising passing a pulsed signal received from a photodiode to an amplifier and passing the pulsed signal from said amplifier directly to a rectifier, each of said pulsed signals from said amplifier being fully amplified signals.

According to a further aspect of the invention, there is provided a circuit for a flame sensor comprising a photodiode for sensing flame flicker and generating a pulsed signal, an amplifier for receiving said pulsed signal and for amplifying said pulsed signal and a rectifier for receiving said pulsed signal directly from said amplifier, said pulsed signal from said amplifier being a fully amplified signal.

### BRIEF DESCRIPTION OF THE SEVERAL VIEWS OF THE DRAWINGS

Specific embodiments of the invention will now be described, by way of example only, with the use of drawings in which:

FIG. 1A is a diagrammatic schematic of the flame sensor by way of photodiode which incorporates the amplifier circuitry according to a first aspect of the invention;

FIG. 1B is similar to FIG. 1A but illustrates the use of a flame sensor which is a photoresistor rather that the photodiode of FIG. 1A;

FIG. 2A is a diagrammatic schematic of the missing pulses detector and sensor supervisor used for monitoring the flame sensor signal and the integrity of the connections between the amplifier and the microcontroller;

FIG. 2B is a diagrammatic and enlarged schematic particularly illustrating the connections between the amplifier and the microcontroller, the missing pulses detector and the supervisory circuit;

FIGS. 3A-3F are diagrammatic schematics of the main board which includes the missing pulses detector and the sensor supervisor of FIGS. 2A and 2B;

FIGS. 4A and 4B are diagrammatic isometric cutaway views of the housings used to house the flame sensor, the amplifier, the sensor supervisor and their related circuitry;

FIG. 5 is a diagrammatic isometric view of a housing but not being illustrating in cutaway;

FIG. 6 is a diagrammatic isometric view illustrating the position of the flame sensor relative to the flame being sensed;

FIG. 7 is a diagrammatic isometric view of a powered multifuel burner which utilises the flame sensor according to the invention; and

FIG. 8 is a diagrammatic schematic illustrating a modified circuit for the flame sensor.

### DESCRIPTION OF SPECIFIC EMBODIMENT

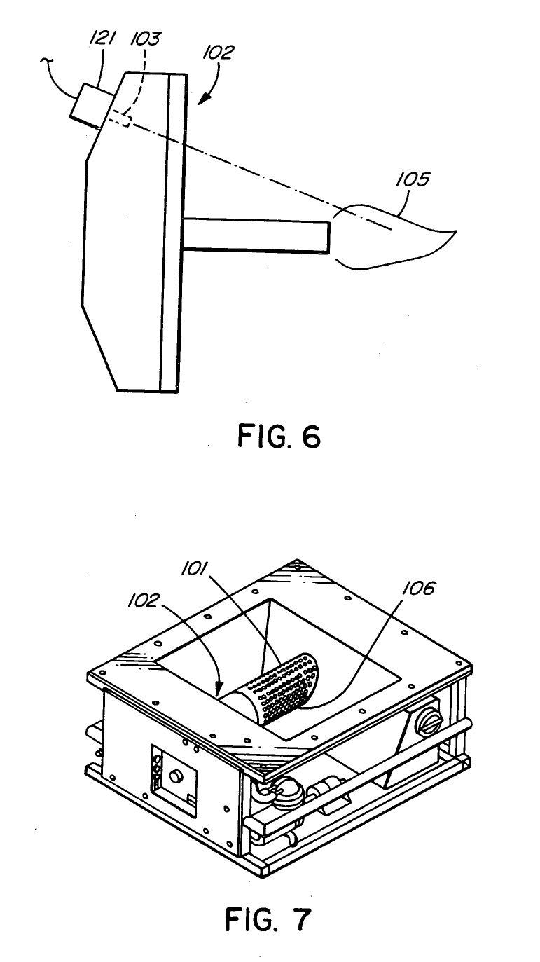

Referring now to the drawings, a powered multifuel burner is generally illustrated at 100 in FIG. 7. An infrared type burner 101 has a flame 105 (FIG. 6) generated within the cylinder 106 of the burner 101 by way of an air aspirated nozzle (not shown) which uses a venturi effect to draw fuel into the nozzle. Combustion takes place outside the nozzle but within the cylinder 106. The flame sensor 110 is located generally at 102 as illustrated in FIG. 6.

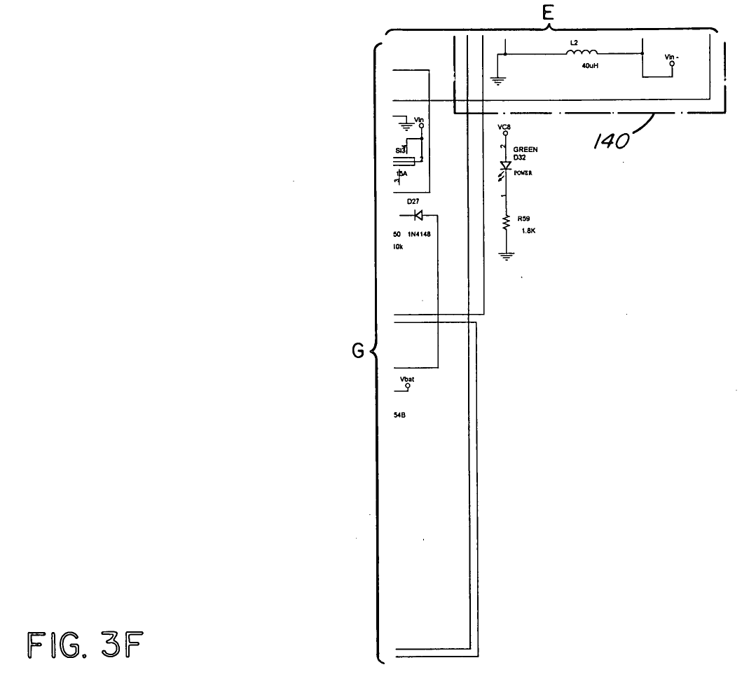

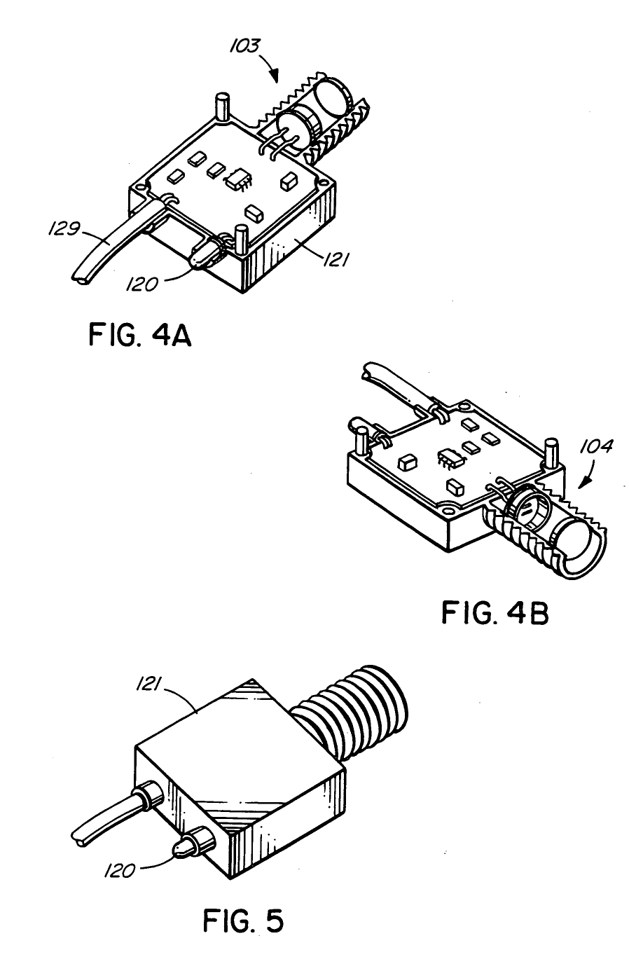

The flame sensor 110 may include either an infrared sensor or an ultraviolet sensor or, alternatively, a combination of an infrared and ultraviolet sensor. Each or both of the sensors 103 are positioned in the housing 121 (FIG. 4A) to sense the visible infrared and ultraviolet radiation produced by the combustion flame. The sensors 103 selected for the particular application will depend on the flame being produced within the burner 100. If, for example, the flame burns with an orange patina, the primary sensor will be infrared. Alternatively, if the flame burns primarily with blue radiation, an ultraviolet sensor will be utilised.

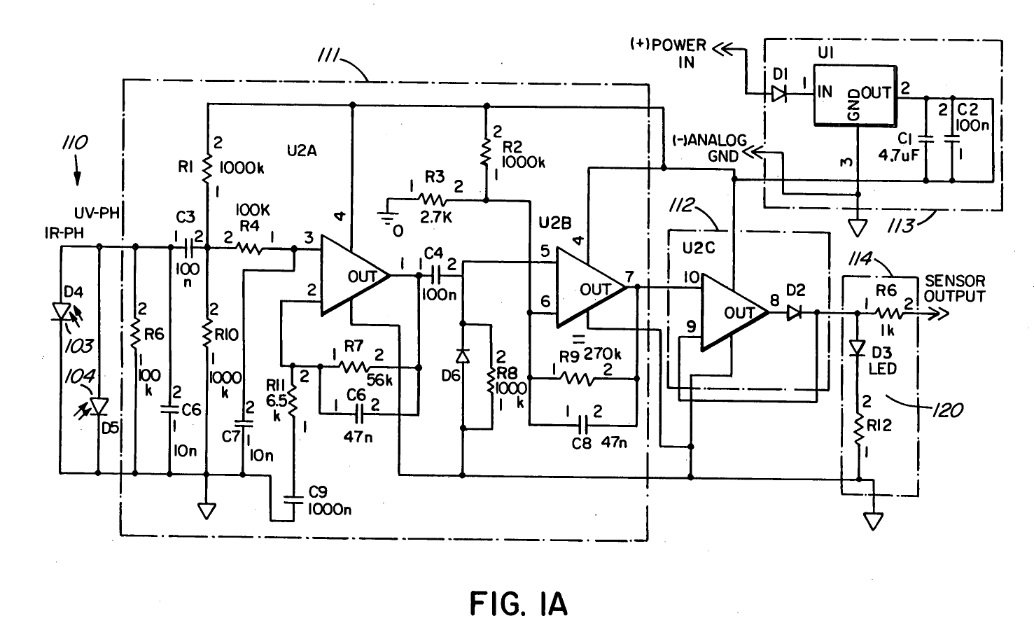

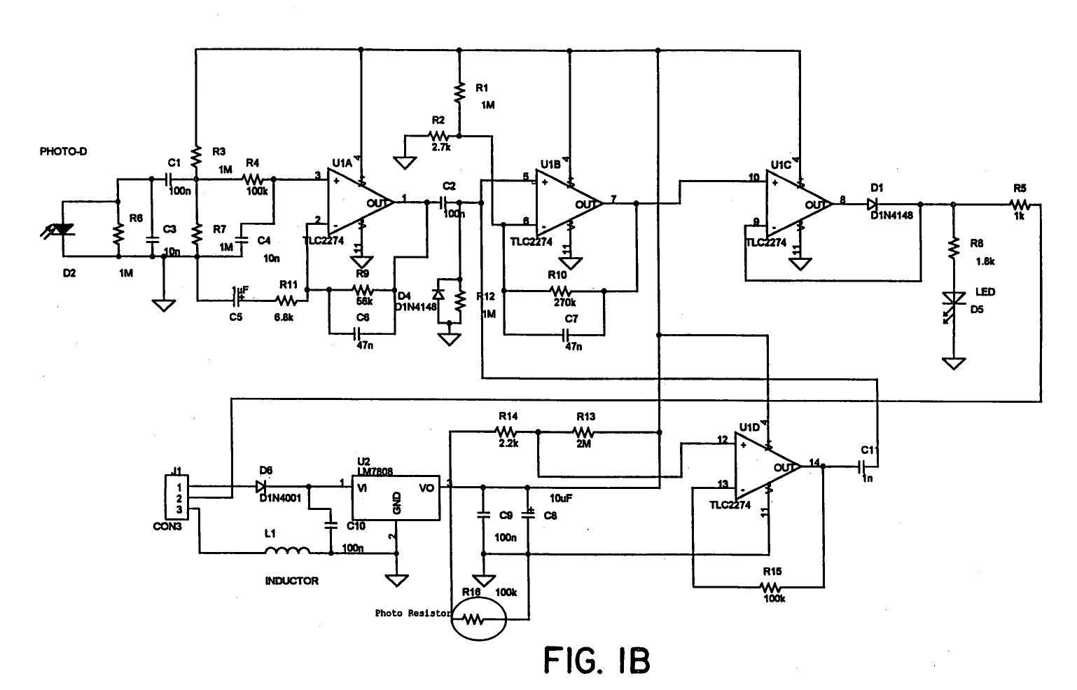

The schematic of FIG. 1 discloses both infrared and ultraviolet sensors 103, 104 and their related circuitry. The sensors 103, 104 are photodetectors shown generally at 110. The output from the sensors 103, 104 passes to a real to real integrator amplifier section 111. A rectifier 112 rectifies the signal passing from the amplifier section 111. A voltage regulator 113 is used to regulate the voltage and a read out circuit 114 is used to show the conditions of the signal passing from the sensors 103, 104, the amplifier 111 and rectifier 112. The read our circuit is exemplified by an LED generally shown at 120 in FIGS. 1 and 4A.

All of the components of the schematic of FIG. 1 are included with the sensors 103, 104 and are mounted within the housing 121 (FIGS. 4A, 4B and 5) associated with the sensors 103, 104. It will thereby be seen that the components described, particularly the amplifier circuit 111, are located closely to the sensors 103, 104 and, indeed, are directly connected thereto to avoid the need for cables and the like to run from the sensors 103 to the main board 124 where further processing is accomplished. This allows the relatively small signal generated by the sensors 103, 104 to be amplified without the signal picking up noise from ground terminal and RF radiation which may be present and picked up by the cables if the sensors 103, 104 were separated from the amplifier 111 which otherwise would be located in the main board 124.

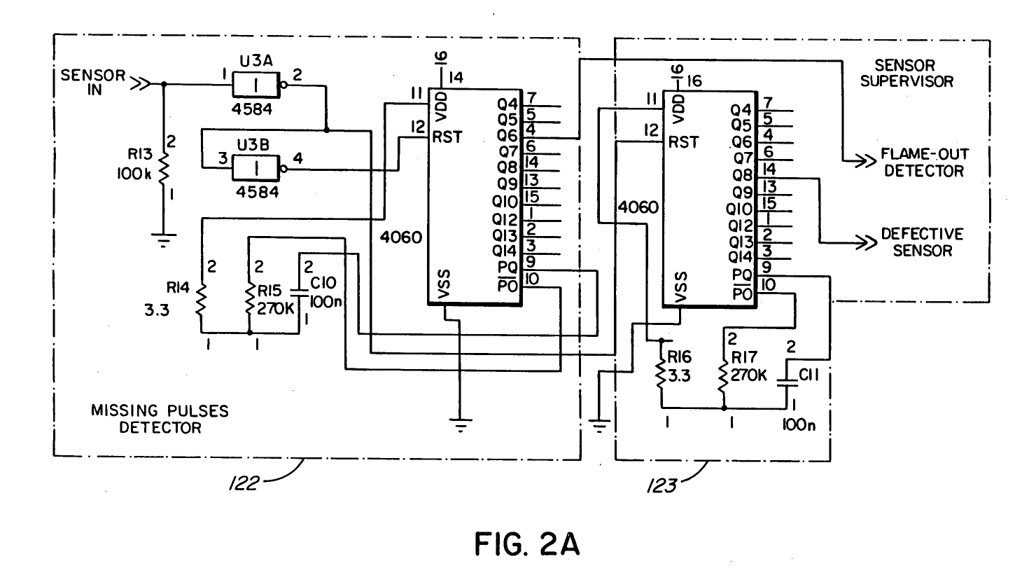

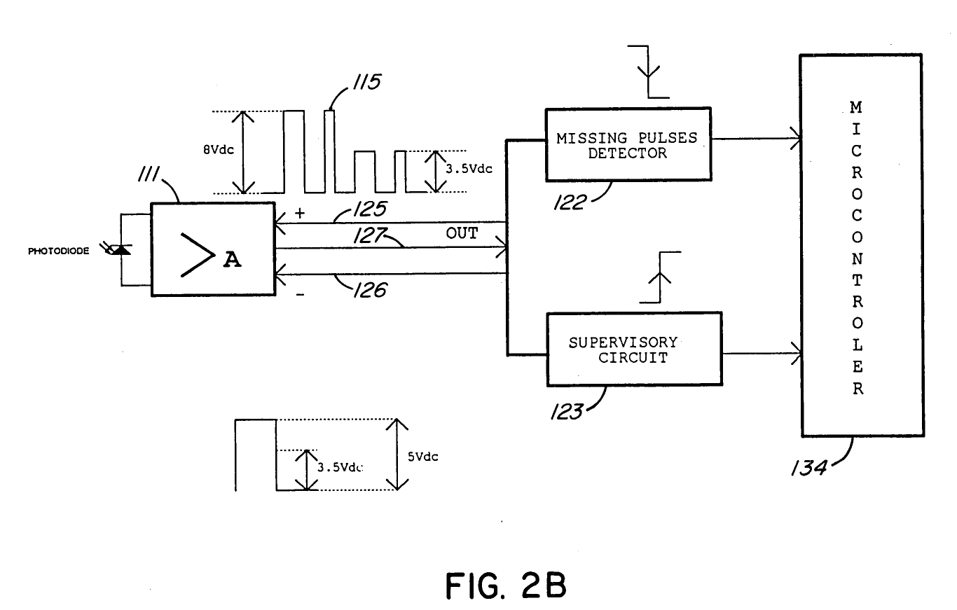

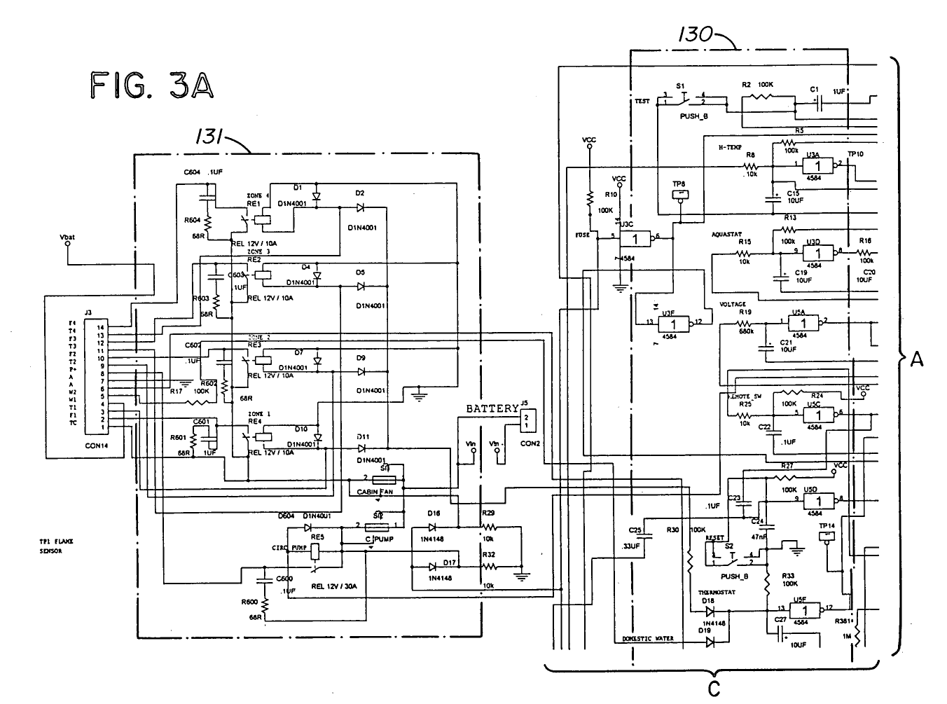

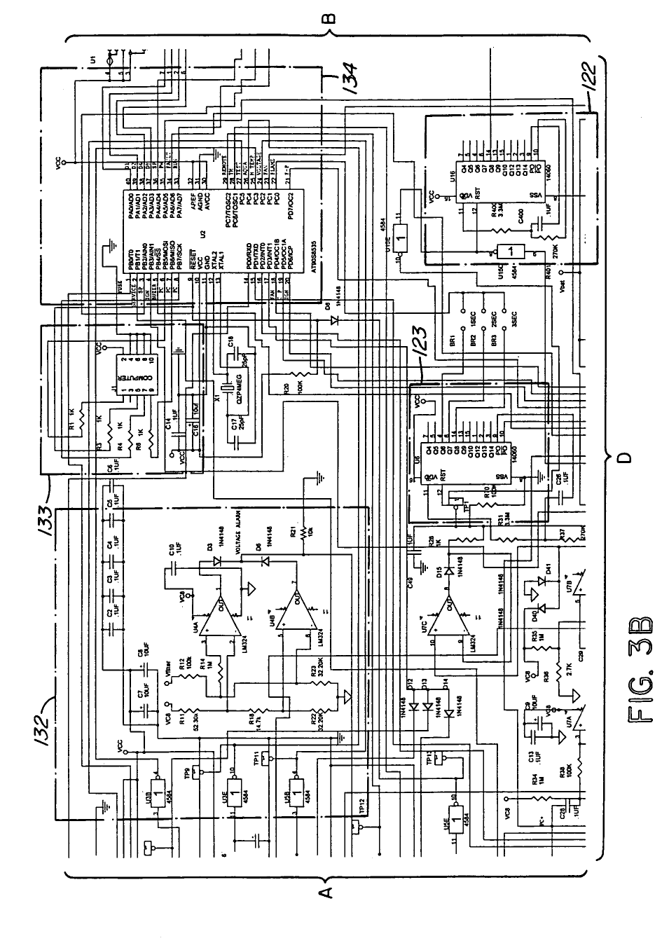

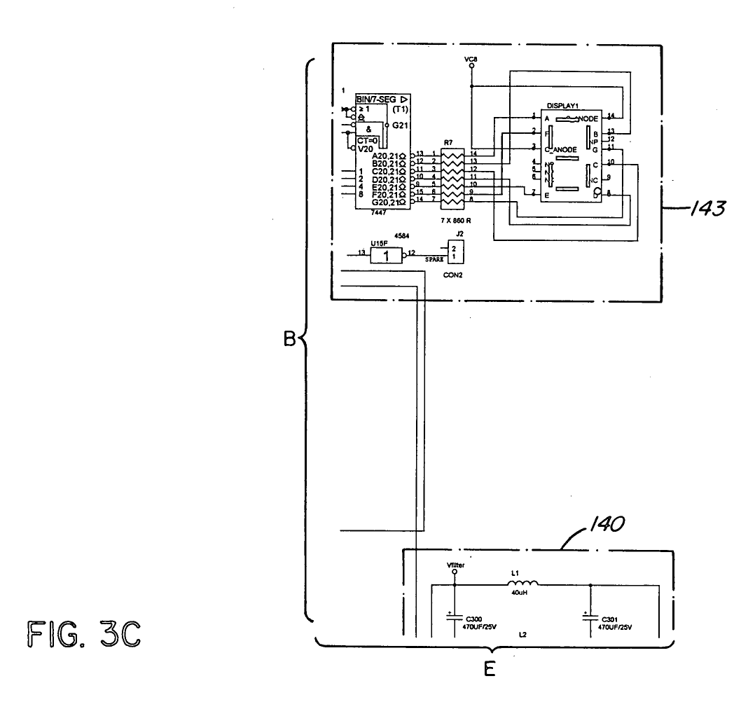

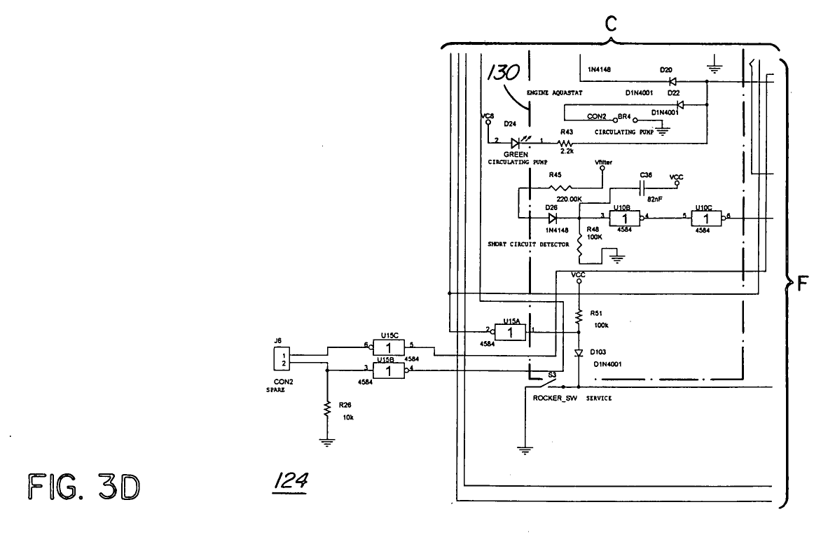

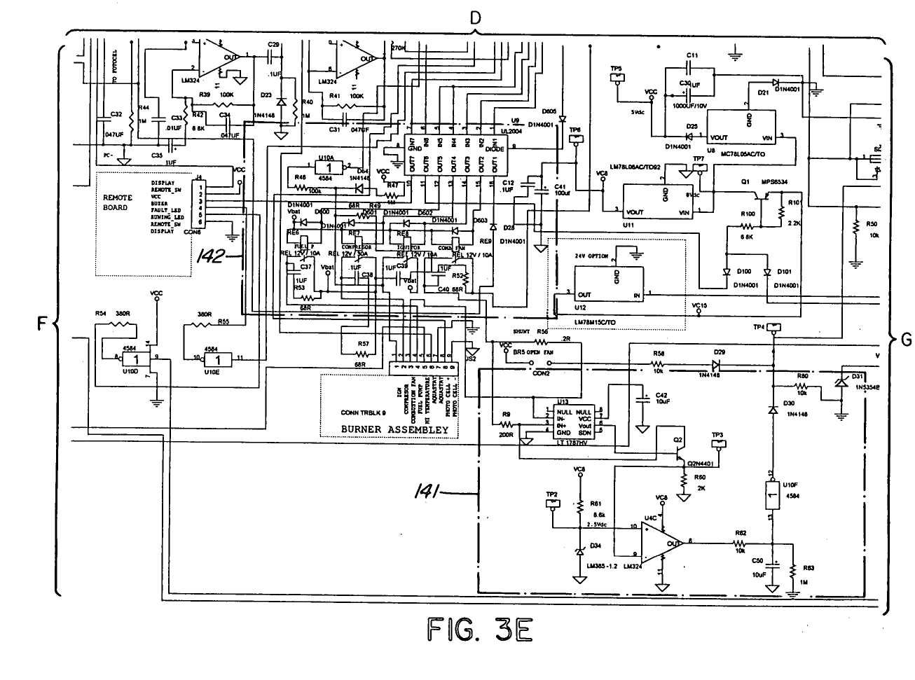

The missing pulse detector and the sensor supervisor are generally illustrated at 122, 123, respectively, in FIG. 2. These circuit components are located remotely from the sensor housing 121 and on the main board illustrated generally at 124 in FIG. 3. These components 122, 123, as well as the remaining main board circuit components which will be described are separated from the components of FIG. 1 by cable 129 (FIG. 4A) and are remote from the housing 121 of the sensors 103, 104.

Referring to FIGS. 2B and 3, the missing pulses detector 122 and the sensor supervisor 123 are shown in greater detail and are included on the main board 124. In addition, the burner interface circuitry 130, zone board 131, voltage supervisor 132, computer interface 133, microcontroller 134, filter 140, open circuit for combustion fan supervisory 141 and relay driver 142 are further included on the main board 124. A display unit 143 is included on the main board 124 which shows the status of the various functions of the burner 100.

### Operation

In operation, combustion of the fuel in burner 100 (FIG. 5) will be initiated and, following the initiation of the combustion, the sensors 103, 104 will be activated to monitor the flame of the burner 100. At the beginning of the ignition, the flame sensors 103, 104 receive power. The sensors 103, 104 are located adjacent the flame of the burner 100 (FIG. 6) and sense the infrared and ultraviolet radiation, respectively, emanating from the flame 105. The circuitry associated with the flame sensors 103, 104 generates a series of pulses 115 (FIG. 2B) read by the missing pulses detector 122. In the event the flame shuts down, no pulses will be generated with the result that the missing pulses detector 122 will sense the missing pulses and instruct the microcontroller 134 accordingly in order to shut down the burner 100.

The signal from the photodetectors or sensors 103, 104 will pass to the real to real integrator amplifier 111 and, thence, to rectifier 112. Voltage regulator 113 will regulate the voltage of the signal generated by the amplifier 111 and the signal leaving rectifier 112 will pass to the missing pulses detector 122. The LED 120 will show the status of the sensors 103, 104 while under operation.

The signal from the rectifier 112 which passes to the missing pules detector 122 will appear at “A” in FIG. 4A. The remaining circuitry illustrated in FIG. 3, including the missing pules detector 122 and the sensor supervisor 123 are located remotely from the sensors 103, 104, by way of cables 125, 126, 127 (FIG. 2B).

With reference to FIG. 3, the remaining circuitry related to the sensors 103, 104 is illustrated. Such circuitry includes circuitry relating to the operation of the burner 100 and the various functions that the burner 100 must fulfil. However, the circuitry described and its position within the housing 121 adjacent to the sensors 103, 104 allow the signal from the sensors 103, 104 to be amplified prior to conveying the signal to the main board 124 with the result than any noise or other RF frequency added to the signal is relatively much smaller than the amplified signal leaving from “B” of FIG. 1 with the result that the signal is relatively clean and may be clearly determined by the missing pulses detector 122 and supervisor circuit 123 so as to determine the condition of the flame in the burner 100 without fear of common mode RF radiation that might otherwise be gathered by the cables 125, 126, 127 creating an erroneous signal to the missing pulses detector 124 and sensor supervisor 123.

If the burner 100 terminates operation, it may be desirable to determine the reason for such shutdown. There are several problems that may cause such shutdown as described hereinafter.

First and most likely, the burner 100 becomes starved for fuel because of fuel exhaustion. In this event, the flame out condition will initiate operation of the microcontroller 134 in an attempt to again commence operation of the burner 100. This in intended, for example, to deal with the problem of an air bubble in the fuel line to the burner 100. If, following three(3) attempts to commence operation of the burner 100, the burner 100 fails in continued operation, the burner 100 will remain in its shutdown condition and operator intervention will be required.

Second, it may be that the positive wires 125 (FIG. 2B) become disconnected between the amplifier 111 and the microcontroller 134 of the main board 124. In this event, the burner 100 will be in the shutdown condition and the operator will initiate power flow to the burner 100. The LED 120 will not flash since the circuit between the amplifier 111 and the main board 124 is not complete. The operator will then know that either the positive or ground wires 125, 126 are defective.

If LED 120 flashes when power flow commences, the positive and ground wires 125, 126 are not the reason for the shutdown and the burner 100 will commence operation. If the LED 120 is not flashing when the flame is again present, the sensor 103 itself is at fault. If the LED 120 is flashing and the sensor 103 is functioning, it indicates that the signal wire 127 between the amplifier 111 and the main board is defective.

The time of burner shutdown and the number of attempted restarts of the burner may, of course, be clearly changed by appropriate programming of the microcontroller 134. The sensor 103 can operate into a range of 8-40 VDC supply voltage. The signal and the output will be in the range of 0-8 VDC if the output signal stays at high level (over 3.5 VDC) for a period of time which exceeds the present time in the sensor supervisory circuit and an alarm signal will be generated by the sensor supervisory circuit to the microcontroller 134 to shut down the burner.

While a photodiode and a photoresistor have been illustrated and described, various other sensors could likewise be used including a phototransistor and a photocell.

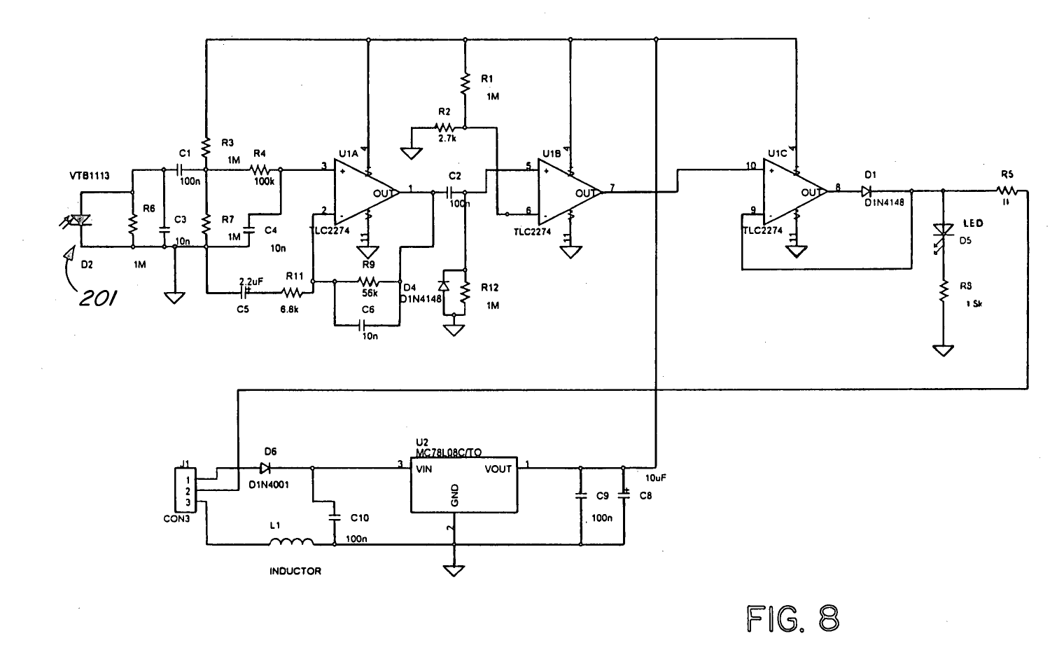

In a further embodiment of the invention, reference is now made to FIG. 8 wherein a modified circuit for the flame sensor is generally illustrated at 200. In this circuit, the photodiode being the flame sensor 201 generates a voltage corresponding to the brightness of the flame, mainly in the red and near infrared regions. Its response extends into the blue but the output is much lower. However, the photodiode 201 is a very high speed device and its output had a high flicker content, in step with the flicker of the flame. The photodiode 201 is a photovoltaic device thereby generating electricity as a result of the light it receives from the flame.

The signal from the photodiode 201 is passed through C1 which blocks the actual brightness component of the flame and leaves only the “flicker” signal. This makes the circuit 200 insensitive to ambient light which does not flicker. The circuit 200 thereby allows for the use of different fuels which burn at different brightnesses.

The flicker signal is amplified by amplifier U1A and passes through C2 where the signal is moved from a biased reference to a ground reference by R12 and D4. This flicker signal is further amplified by amplifier U1B and detected by U1C, a generally lossless rectifier circuit.

It will be particularly noted that the feedback loop between the output of U1B and the inverting input of U1B has been eliminated with the result that there is no noise added to the inverting input of U1B. This allows increased amplification of the signal leaving U1B which results in the full amplification of every pulse signal generated by the photodiode 201 from the flicker of the flame thereby allowing greater reading sensitivity of the pulsed signal generated by the photodiode 201.

Many modifications will readily occur to those skilled in the art to which the invention relates and the specific embodiments described should be taken as illustrative of the invention only and not as limiting its scope as defined in accordance with the accompanying claims.

I claim:

1. A method of sensing a flame using an amplifier circuit comprising passing a pulsed signal received from a photodiode to an amplifier and passing the pulsed signal from said amplifier directly to a rectifier, each of said pulsed signals from said amplifier being fully amplified signals.

2. Circuit for a flame sensor comprising a photodiode for sensing flame flicker and generating a pulsed signal, an amplifier for receiving said pulsed signal and for amplifying said pulsed signal and a rectifier for receiving said pulsed signal directly from said amplifier, said pulsed signal from said amplifier being a fully amplified signal.
